(19) United States
(12) Patent Application Publication
(10) Pub. No.: US 2021/0400240 A1
(43) Pub. Date: Dec. 23, 2021

(54) IMAGE PROCESSING APPARATUS, IMAGE PROCESSING METHOD, AND COMPUTER READABLE MEDIUM

(71) Applicant: NEC Corporation, Minato-ku, Tokyo (JP)

(72) Inventor: Takashi KOJIMA, Tokyo (JP)

(73) Assignee: NEC Corporation, Minato-ku, Tokyo (JP)

(21) Appl. No.: 17/289,469

(22) PCT Filed: Nov. 7, 2018
(86) PCT No.: PCT/JP2018/041318

§ 371 Date: Apr. 28, 2021

(51) Int. Cl. H04N 7/18; H04N 5/445; G08B 13/186; G08B 13/196

(52) U.S. Cl. CPC H04N 7/181; G08B 13/19693; G08B 13/186; H04N 5/445

(57) ABSTRACT

An image processing apparatus (40) according to the present disclosure includes a display unit (42) and a control unit (41) configured to control the display unit (42) to display a sensing data image indicating sensing data of an optical fiber and a camera image of a camera (50) which photographs an area in which a predetermined event is detected by the sensing data.

### TECHNICAL FIELD

The present disclosure relates to an image processing apparatus, an image processing method, and a computer readable medium.

### BACKGROUND ART

In related techniques, an abnormality in a monitoring target such as a fence has been monitored by a monitoring person in a monitoring room monitoring camera images of a plurality of cameras. For example, when the monitoring person determines that there is a suspicious point in the monitoring target, he/she turns the orientation of the camera towards the monitoring target and controls the camera to zoom in so as to detect an abnormality in the monitoring target. However, it may take a lot of time for a human to detect an abnormality in a monitoring target, which delay may cause a large increase in the cost of finding and handling the abnormality.

Thus, recently, a system for monitoring an abnormality in a monitoring target using an optical fiber has been proposed (e.g., Patent Literature 1).

In the technique described in Patent Literature 1, an optical fiber detection sensor identifies a deflection and the like generated in a fence, and detect an intrusion of a moving body such as a person, and also a place and so on where the intrusion is detected. Then, the photographed video of the current camera showing the moving object and the photographed video of a camera adjacent to the current camera are displayed separately on the same screen.

### CITATION LIST

### Patent Literature

Patent Literature 1: Japanese Unexamined Patent Application Publication No. 2009-017416

### SUMMARY OF INVENTION

### Technical Problem

The technique described in Patent Literature 1 displays a camera image of a camera in which a moving body appears and a camera image of a camera adjacent to the camera. However, there is a problem that it is difficult for a monitoring person to visually recognize that an abnormality has occurred from only a display of a camera image.

Thus, an object of the present disclosure is to provide an image processing apparatus, an image processing method, and a computer readable medium that can solve the above-described problem and can display an image in such a way that an occurrence of an abnormality can be visually recognized easily.

### Solution to Problem

In an example aspect, an image processing apparatus includes:

a display unit; and

a control unit configured to control the display unit to display a sensing data image indicating sensing data of an optical fiber and a camera image of a camera which photographs an area in which a predetermined event is detected by the sensing data.

In another example aspect, an image processing method performed by an image processing apparatus includes:

acquiring a sensing data image indicating sensing data of an optical fiber and a camera image of a camera which photographs an area in which a predetermined event is detected by the sensing data; and

displaying the sensing data image and the camera image.

In another example aspect, a non-transitory computer readable medium storing a program causing a computer to execute:

a procedure for acquiring a sensing data image indicating sensing data of an optical fiber and a camera image of a camera which photographs an area in which a predetermined event is detected by the sensing data; and

a procedure for displaying the sensing data image and the camera image.

### Advantageous Effects of Invention

According to the above-described aspects, it is possible to achieve an effect that an image can be displayed in such a way that an occurrence of an abnormality can be visually recognized easily.

### BRIEF DESCRIPTION OF DRAWINGS

FIG. 1 shows an example of a configuration of a monitoring system according to a first embodiment;

FIG. 2 is an overhead view showing an example of an entire area where fences according to a first embodiment are installed as seen from above;

FIG. 3 shows an example of fence location information according to the first embodiment;

FIG. 4 shows an example of sensing data generated by an optical fiber detection unit according to the first embodiment;

FIG. 5 shows an example of machine learning by a control unit according to the first embodiment;

FIG. 6 shows an example of fence event information according to the first embodiment;

FIG. 7 shows an example of camera information according to the first embodiment;

FIG. 8 shows a Display Example 1 of a display unit according to the first embodiment;

FIG. 9 shows another example of sensing data generated by the optical fiber detection unit according to the first embodiment;

FIG. 10 shows still another example of the sensing data generated by the optical fiber detection unit according to the first embodiment;

FIG. 11 shows a modified example of the Display Example 1 of the display unit according to the first embodiment;

FIG. 12 is shows the modified example of the Display Example 1 of the display unit according to the first embodiment;

FIG. 13 shows the modified example of the Display Example 1 of the display unit according to the first embodiment;

FIG. 14 shows a Display Example 2 of the display unit according to the first embodiment;

FIG. 15 shows a Display Example 3 of the display unit according to the first embodiment;

FIG. 16 is a block diagram showing an example of a hardware configuration of a computer that implements an image processing apparatus according to the first embodiment;

FIG. 17 is a flowchart showing an example of an operation flow of the image processing apparatus according to the first embodiment;

FIG. 18 is an overhead view of an example of an entire room in which fences according to a second embodiment are installed as seen from above;

FIG. 19 shows an example of a method of laying an optical fiber cable on the fences according to the second embodiment;

FIG. 20 shows a Display Example 1 of a display unit according to the second embodiment;

FIG. 21 shows a Display Example 2 of the display unit according to the second embodiment;

FIG. 22 shows a modified example of the Display Example 2 of the display unit according to the second embodiment.

FIG. 23 shows the modified example of the Display Example 2 of the display unit according to the second embodiment;

FIG. 24 shows the modified example of the Display Example 2 of the display unit according to the second embodiment;

FIG. 25 shows the modified example of the Display Example 2 of the display unit according to the second embodiment;

FIG. 26 shows a Display Example 3 of the display unit according to the second embodiment;

FIG. 27 shows a Display Example 4 of the display unit according to the second embodiment; and

FIG. 28 shows a Display Example 5 of the display unit according to the second embodiment.

### DESCRIPTION OF EMBODIMENTS

Hereinafter, an embodiment of the present disclosure will be described with reference to the drawings. In the embodiment described below, as an example, a monitoring target to be monitored is described as a fence, but the monitoring target is not limited to a fence.

### First Embodiment

### Configuration of First Embodiment

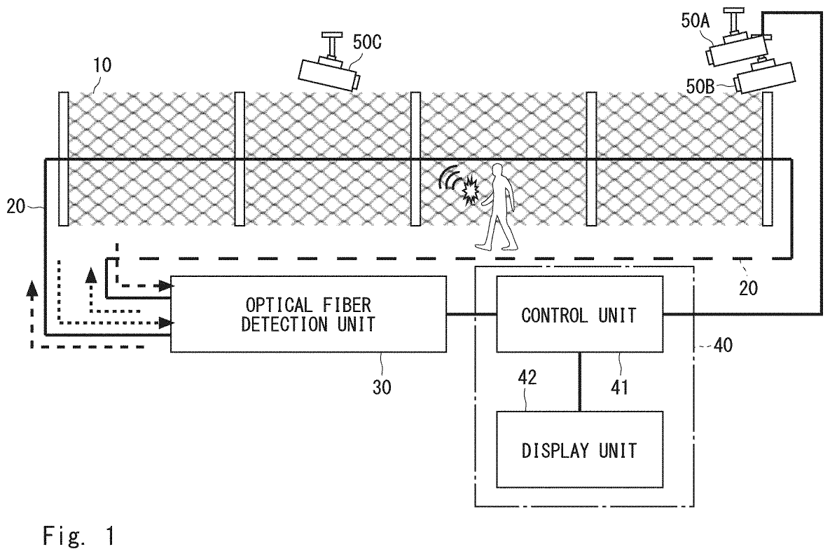

First, a configuration of a monitoring system according to this embodiment will be described with reference to FIG. 1.

As shown in FIG. 1, the monitoring system according to the first embodiment monitors fences 10. The monitoring system includes an optical fiber cable 20, an optical fiber detection unit 30, an image processing apparatus 40, and a plurality of cameras 50 (in FIG. 1, three cameras 50A to 50C). The image processing apparatus 40 includes a control unit 41 and a display unit 42. Note that the fence 10 may be composed of one fence. However, in the first embodiment, the fences 10 are composed of a plurality of fences 10 connected to each other.

The optical fiber cable 20 is formed by covering one or more optical fibers. The optical fiber cable 20 is laid on the fences 10 and buried in the ground along the fences 10. Specifically, the optical fiber cable 20 extends from the optical fiber detection unit 30 along the fences 10 and is turned back at a turning point and returns to the optical fiber detection unit 30. A part of the optical fiber cable 20 between the optical fiber detection unit 30 and the turning point is laid on the fences 10, and the other part of the optical fiber cable 20 is buried in the ground along the fences 10. However, the method of laying and burying the optical fiber cable 20 shown in FIG. 1 is an example and is not limited to this.

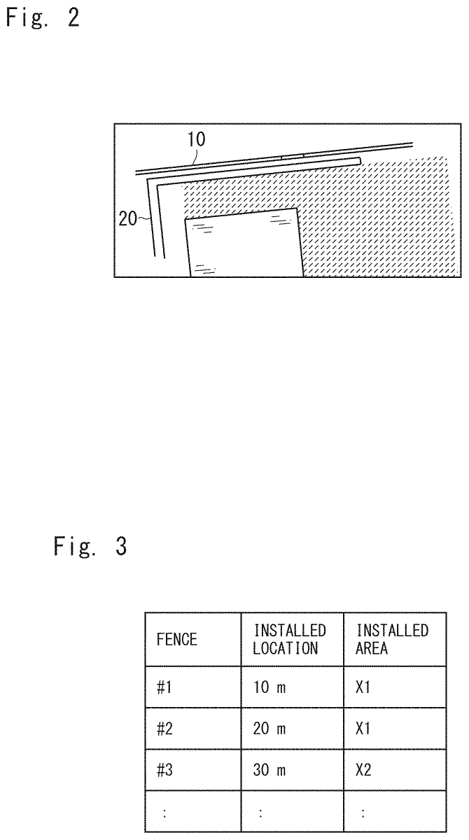

FIG. 2 shows a more specific example of the entire area where the fence 10 according to the first embodiment is installed and is an overhead view of the entire area as seen from above. As shown in FIGS. 1 and 2, the first embodiment is an example in which the fence 10 are installed outdoors.

The camera 50 photographs an area where the fences 10 are installed. The camera 50 is implemented by, for example, a fixed camera, a PTZ (Pan Tilt Zoom) camera, or the like. The plurality of cameras 50 may be installed so that the entire area where the fences 10 are installed can be photographed, although the number of installed cameras 50 and an installation spacing between the cameras 50 are not particularly limited. For example, when a high-performance camera 50 having a long maximum shooting distance is used, the number of installed cameras can be reduced and the installation spacing between the cameras 50 can be increased.

The monitoring system according to the first embodiment monitors the fences 10 and its surroundings using an optical fiber sensing technique that uses an optical fiber as a sensor.

Specifically, the optical fiber detection unit 30 makes pulsed light incident on at least one optical fiber included in the optical fiber cable 20. Then, as the pulsed light is transmitted through the optical fiber in the direction of the fences 10, backscattered light is generated at each transmission distance. This backscattered light returns to the optical fiber detection unit 30 via the above-mentioned same optical fiber as the one through which the pulsed light is transmitted.

At this time, the optical fiber detection unit 30 makes the pulsed light incident in the clockwise direction and receives the backscattered light from this pulsed light in the clockwise direction and also makes the pulsed light incident in the counterclockwise direction and receives the backscattered light from this pulsed light in the counterclockwise direction. Thus, the optical fiber detection unit 30 receives the backscattered light from two directions.

Here, the fence 10 vibrates when an event such as a person grabbing and shaking the fence 10 occurs, and the vibration of the fence 10 is transmitted to the optical fiber. The vibration pattern of the vibration of the fence 10 transmitted to the optical fiber is a dynamically fluctuating pattern and differs according to the type of an event occurring in the fence 10. In the first embodiment, for example, the following events are assumed as predetermined events that occur in the fences 10.

(1) A person grabs the fence 10 and shakes it.
(2) A person hits the fence 10.
(3) A person climbs the fence 10.
(4) A person places a ladder against the fence 10 and climbs the ladder.
(5) A person or an animal wanders around the fence 10.
(6) A person digs around the fence 10.

Thus, the backscattered light received from the optical fiber by the optical fiber detection unit 30 includes a pattern corresponding to the state of the fence 10, i.e., a pattern corresponding to an event occurring in the fence 10. Therefore, in this embodiment, the state of the fence 10 is detected by the method described below by using the fact that the pattern corresponding to the state of the fence 10 is included in the backscattered light. Specifically, a predetermined event occurring in the fence 10 is detected.

The optical fiber detection unit 30 can identify the location of the fence 10 in which this backscattered light is generated based on a time difference between a time when the pulsed light is incident on the optical fiber and a time when the backscattered light is received from this optical fiber. Further, in the first embodiment, as described above, the fences 10 are composed of a plurality of fences 10 connected to each other. Therefore, as shown in FIG. 3, the optical fiber detection unit 30 holds location information indicating installed locations of the plurality of fences 10 (distances from the optical fiber detection unit 30 in this example) and installed areas and the like of the plurality of fences 10, so that the optical fiber detection unit 30 can identify the fence 10 in which this backscattered light is generated from among the plurality of fences 10. Further, the optical fiber detection unit 30 can detect the strength of the vibration of the identified fence 10 by detecting the received backscattered light with a Distributed Vibration Sensor.

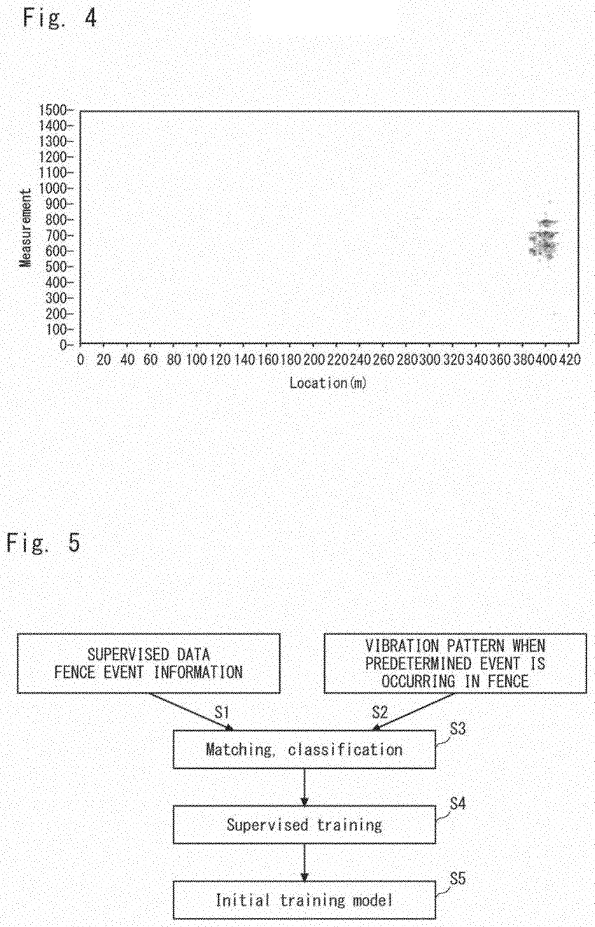

Thus, the optical fiber detection unit 30 can generate, for example, as sensing data vibration data as shown in FIG. 4. In FIG. 4, the horizontal axis represents the location (distance from the optical fiber detection unit 30), and the vertical axis represents the time elapsed.

In the example shown in FIG. 4, a vibration is generated at a location about 400 m away from the optical fiber detection unit 30. A vibration pattern of this vibration is a fluctuation pattern which dynamically fluctuates and differs according to the type of an event occurring in the fence 10 installed at this location.

Thus, in this embodiment, the control unit 41 performs machine learning (e.g., deep learning) on the vibration pattern when a predetermined event is occurring in the fence 10 and detects whether a predetermined event is occurring in the fence 10 using a result of the machine learning (initial training model).

First, a method of the machine learning will be described with reference to FIG. 5.

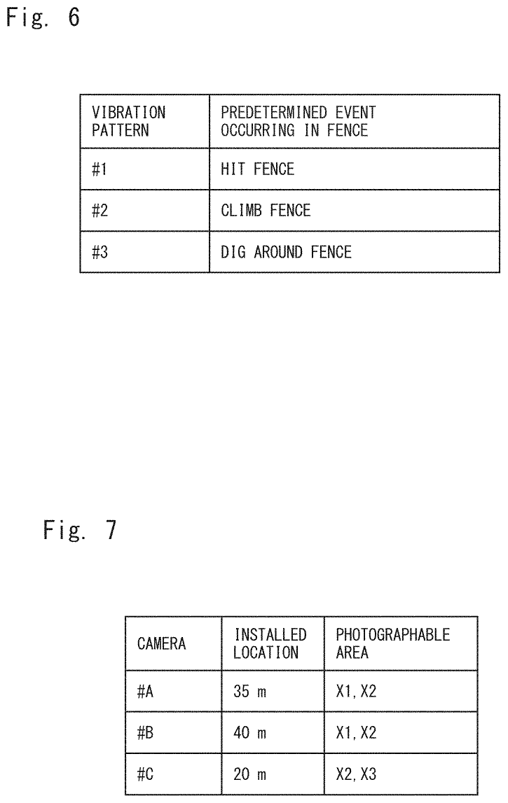

As shown in FIG. 5, a plurality of vibration patterns are prepared when a predetermined event is occurring in the fence 10. The control unit 41 inputs a plurality of vibration patterns and supervised data which is fence event information indicating a predetermined event occurring in the fence 10 when the vibration of the fence 10 matches the corresponding vibration pattern (Steps S1 and S2). FIG. 6 shows an example of the fence event information serving as the supervised data. The fence event information is held by the control unit 41.

Next, the control unit 41 checks the vibration patterns against the supervised data and classifies the vibration patterns (Step S3) and performs supervised learning (Step S4). By doing so, an initial training model is obtained (Step S5). When a vibration pattern corresponding to an event occurring in the fence 10 is input, this initial training model outputs a predetermined event that may be applicable if there is a possibility that this event may correspond to any of the predetermined event. Alternatively, this initial training model may output, together with a predetermined event that may be applicable, confidence with which this predetermined event occurs. Further, an importance of an event based on the confidence and a priority of the event may be displayed. For example, an importance of an event “person climbs fence 10” is set higher, and a priority of this event is set higher than that of an event “person or animal wanders around fence 10” to be output.

Next, a method of determining whether a predetermined event occurring is detected in the fence 10 will be described.

In this case, the control unit 41 first acquires a vibration pattern corresponding to an event occurring in the fence 10 from the optical fiber detection unit 30. Next, the control unit 41 inputs this vibration pattern to the initial training model. By doing so, since the control unit 41 can obtain a predetermined event that may be applicable as a result of the output from the initial training model, it detects that a predetermined event is occurring. Moreover, when the control unit 41 obtains confidence together with a predetermined event that may be applicable as a result of the output from the initial training model, it may determine that the predetermined event occurring is detected if the confidence is more than or equal to a threshold.

As described above, in this embodiment, the vibration pattern when a predetermined event is occurring in the fence 10 is machine-learned, and a result of the machine learning is used to detect a predetermined event occurring in the fence 10.

It may be difficult in an analysis by a human to extract, from data, features for detecting a predetermined event occurring in the fence 10. In this embodiment, by building a training model from a large number of patterns, it is possible to detect a predetermined event occurring in the fence 10 with high accuracy even when it is difficult in an analysis by a human to do so.

Note that in the machine learning according to this embodiment, in the initial state, a training model may be generated based on two or more pieces of supervised data. In addition, this training model may be made to newly learn a newly detected pattern. At this time, a specific condition for detecting a predetermined event occurring in the fence 10 may be adjusted based on the new training model.

As shown in FIG. 7, the control unit 41 holds camera information indicating installed locations (distances from the optical fiber detection unit 30) of the respective plurality of cameras 50, the photographable area, and so on. The control unit 41 can also acquire the location information of each of the plurality of fences 10 as shown in FIG. 3 from the optical fiber detection unit 30. Therefore, when the control unit 41 detects a predetermined event occurring in the fence 10 as described above, it identifies the camera 50 which photographs an area including the fence 10 in which the predetermined event is detected from among the plurality of cameras 50 based on the above-mentioned camera information and location information of the fence 10 and controls the identified camera 50. For example, the control unit 41 controls an angle (azimuth angle, elevation angle), zoom magnification, and so on of the camera 50.

Additionally, the control unit 41 may control two or more cameras 50 which photograph an area including the fence 10 in which the predetermined event is detected among the plurality of cameras 50. In this case, the function may be divided for each camera 50. For example, at least one of the two or more cameras 50 may photograph a face of a person present in the above-mentioned area, so that the photographed face image is used for face authentication, while another at least one of the two or more cameras 50 may photograph the above-mentioned entire area, so that the photographed image is used for monitoring a behavior of a person or an animal present in the above-mentioned area. Moreover, the two or more cameras 50 may photograph the area with different angles. Furthermore, at least one of the two or more cameras 50 may perform photographing to complement photographing of another camera 50. For example, when there is a blind spot that cannot be photographed by the other camera 50 in the above-mentioned area, the at least one camera 50 may photograph the blind spot.

The display unit 42 is installed in a monitoring room or the like which monitors the entire area where the fences 10 are installed and performs various displays under the control of the control unit 41.

Specifically, the control unit 41 further control the display unit 42 to display, for example, a sensing data image indicating sensing data generated by the optical fiber detection unit 30 and a camera image of the camera 50 which photographs an area including the fence 10 in which a predetermined event is detected based on the sensing data.

Hereinafter, specific Display Examples displayed by the display unit 42 according to the first embodiment will be described.

### (1) Display Example 1

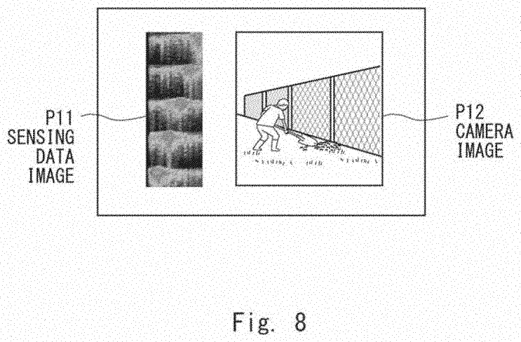

First, a Display Example 1 will be described with reference to FIG. 8.

As shown in FIG. 8, in the Display Example 1, a sensing data image P11 and a camera image P12 are displayed. The arrangement relationship between the sensing data image P11 and the camera image P12 is not limited to this example.

The sensing data image P11 indicates sensing data generated by the optical fiber detection unit 30. This sensing data is obtained by arranging vibration data similar to the vibration data shown in FIG. 4 in the vertical direction in time series. Here, the sensing data indicates that a person is moving while hitting the fence 10 and finally digging around the fence 10. Thus, the control unit 41 detects an event that a person is digging around the fence 10 and controls the camera 50 which photographs an area including this fence 10.

The camera image P12 is a camera image of the camera 50 which photographs the area including the fence 10 in which the event that a person is digging the surroundings is detected and is controlled by the control unit 41.

The sensing data image P11 is not limited to one shown in FIG. 8. For example, the sensing data image P11 may indicate only one piece of the vibration data when an event such as a person digging the surroundings is detected (e.g., image indicating vibration data shown in FIG. 4).

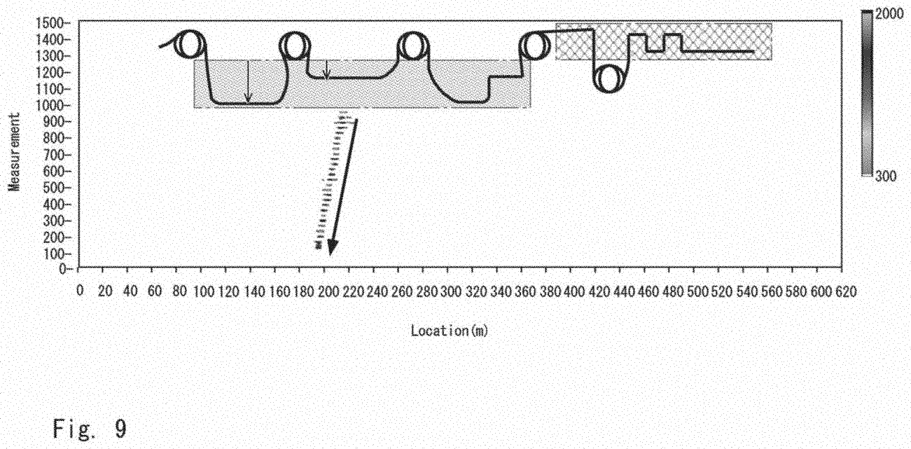

Alternatively, as shown in FIG. 9, the sensing data image P11 may indicate sensing data in which data representing a laying and burying status of the optical fiber cable 20 is superimposed on the vibration data shown in FIG. 4. Alternatively, data indicating the laying and burying status of the optical fiber cable 20 may be displayed outside the upper or lower frame of the sensing data. Further alternatively, another display method may be employed as long as it displays information about the length of the horizontal axis of the sensing data corresponding to the laying and burying status of the optical fiber cable 20.

In the sensing data shown in FIG. 9, the laying and burying status of the optical fiber cable 20 is shown at the upper part of the image.

The horizontally long rectangle in the range of about 90 m to 370 m from the optical fiber detection unit 30 indicates the underground, and an upper side of this horizontally long rectangle indicates a boundary with the ground. That is, in this range, the sensing data shown in FIG. 9 indicates that the optical fiber cable 20 is buried underground and also indicates the depth of the optical fiber cable 20 from the ground.

Further, a horizontally long rectangle in the range of about 390 m to about 560 m from the optical fiber detection unit 30 indicates the fence 10, and a lower side of this horizontally long rectangle indicates a boundary with the ground. That is, in this range, the sensing data shown in FIG. 9 indicates that the optical fiber cable 20 is laid on the fence 10 and also shows the height of the optical fiber cable 20 from the ground.

In the sensing data shown in FIG. 9, with reference to the vibration data, it can be seen that an oblique line is observed from about 190 m to about 220 m from the optical fiber detection unit 30. This indicates that a person has wandered around this area.

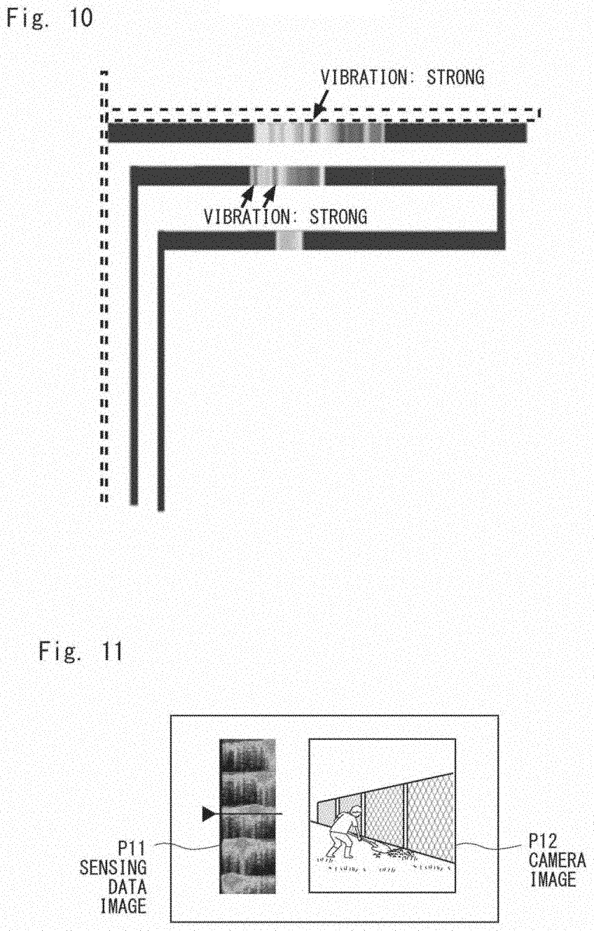

Alternatively, the sensing data image P11 may indicate the sensing data as shown in FIG. 10. The sensing data shown in FIG. 10 is data in which the optical fiber cable 20 laid on the fences 10 or buried along the fences 10 is viewed from above and visually indicates the strength of vibrations at respective points on the optical fiber cable 20 by different concentrations.

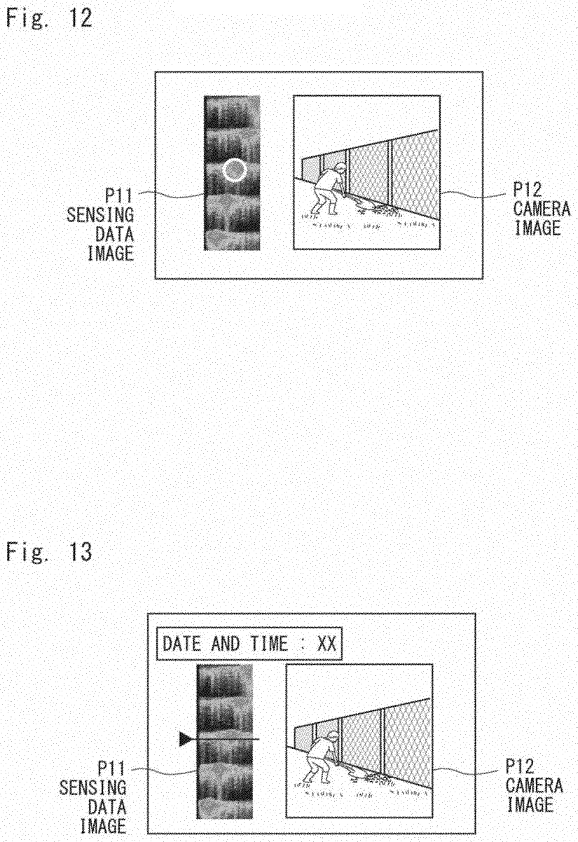

In addition, as for the sensing data image P11 and the camera image P12, by a user (e.g., monitoring person or the like in a monitoring room, which will be hereinafter the same) designating a specific period of time or time, the sensing data P11 at the designated time and the camera image P12 of the camera 50 corresponding to the location of the detected vibration data may be displayed. Specifically, as shown in FIG. 11, the user designates a predetermined period of time on the vertical axis of the sensing data image P11. The control unit 41 identifies the vibration data detected at this predetermined period of time and displays the camera image P12 of the camera 50 corresponding to the location of the vibration data. Further, as shown in FIG. 12, the user may designate not only the predetermined period of time on the vertical axis of the sensing data image P11 but also the place on the horizontal axis. The control unit 41 displays the camera image P12 of the camera 50 corresponding to the predetermined period of time and place designated by the user. Furthermore, as shown in FIG. 13, the user may designate a predetermined date and time. The control unit 41 identifies the sensing data image P11 at a predetermined interval before and after the designated date and time (e.g., one hour before and one hour after the designated date and time) and the vibration data detected at the designated date and time and displays the camera image P12 of the camera 50 corresponding to the location of the identified vibration data.

### (2) Display Example 2

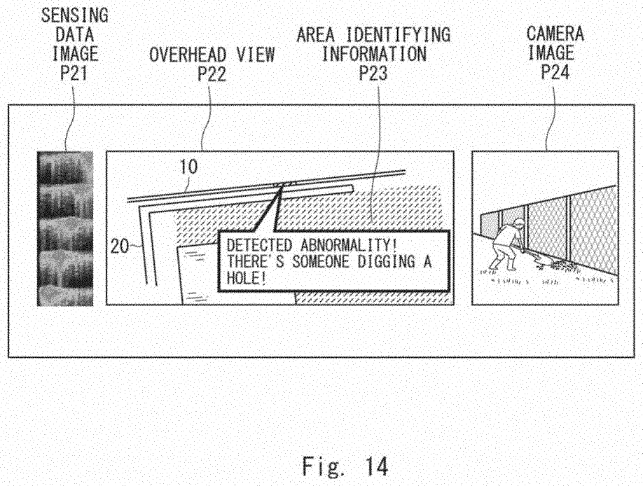

Next, a Display Example 2 will be described with reference to FIG. 14.

As shown in FIG. 14, in the Display Example 2, a sensing data image P21, an image in which area identifying information P23 is superimposed on an overhead image P22, and a camera image P24 are displayed. Note that an arrangement relationship of the sensing data image P21, the image in which the area identifying information P23 is superimposed on the overhead image P22, and the camera image P24 is not limited to this example.

The overhead image P22 is an image of the entire area where the fences 10 are installed as seen from above. Like in the Display Example 1, also in this Display Example 2, the control unit 41 detects an event that a person is digging around the fence 10.

The area identifying information P23 has a balloon shape. The area identifying information P23 indicates by an arrow an area including the fence 10 in which the control unit 41 has detected an occurrence of the above-mentioned event with a warning message that a person is digging around the fence 10. The area identifying information P23 is superimposed on the overhead image P22 and displayed.

The sensing data image P21 and the camera image P24 are similar to the sensing data image P11 and the camera image P12 of FIG. 8, respectively.

### (3) Display Example 3

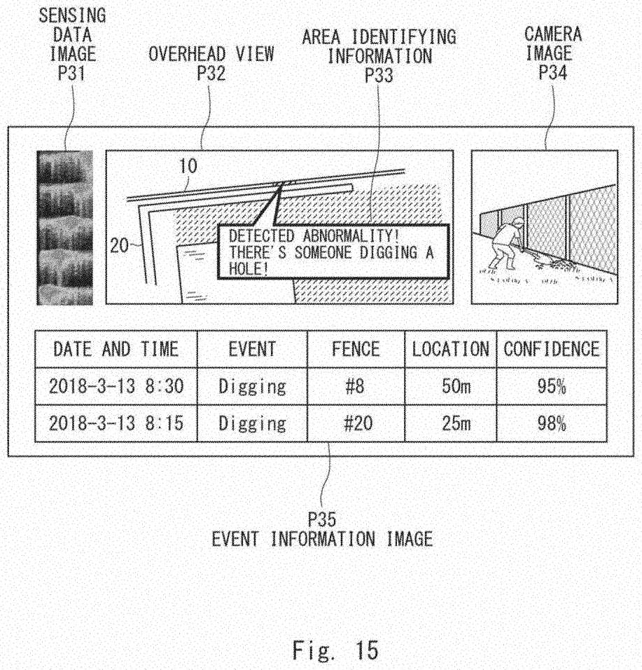

Next, a Display Example 3 will be described with reference to FIG. 15.

As shown in FIG. 15, in the Display Example 3, a sensing data image P31, an image in which area identifying information P33 is superimposed on an overhead image P32, a camera image P34, and an event information image P35 are displayed. Note that an arrangement relationship among the sensing data image P31, the image in which the area identifying information P33 is superimposed on the overhead image P32, the camera image P34, and the event information image P35 is not limited to this example.

The event information image P35 indicates event information representing an occurrence status of an event. In the example of FIG. 15, the event information includes date and time when an event has occurred, a type of the event, the fence 10 where the event has occurred, the location where the event has occurred (distance from the optical fiber detection unit 30), and confidence with which the event has occurred.

Further, the event information image P35 may be configured in such a way that the user can select an event. Specifically, when the user designates a specific event from a plurality of events displayed in the event information image P35, the control unit 41 displays the sensing data image P31, the overhead image P32, and the camera image P34 corresponding to the date and time of this event.

The sensing data image P31 and the camera image P34 are similar to the sensing data image P11 and the camera image P12 of FIG. 8, respectively. The overhead image P32 and the area identifying information P33 are similar to the overhead image P21 and the area identifying information P22 of FIG. 14, respectively.

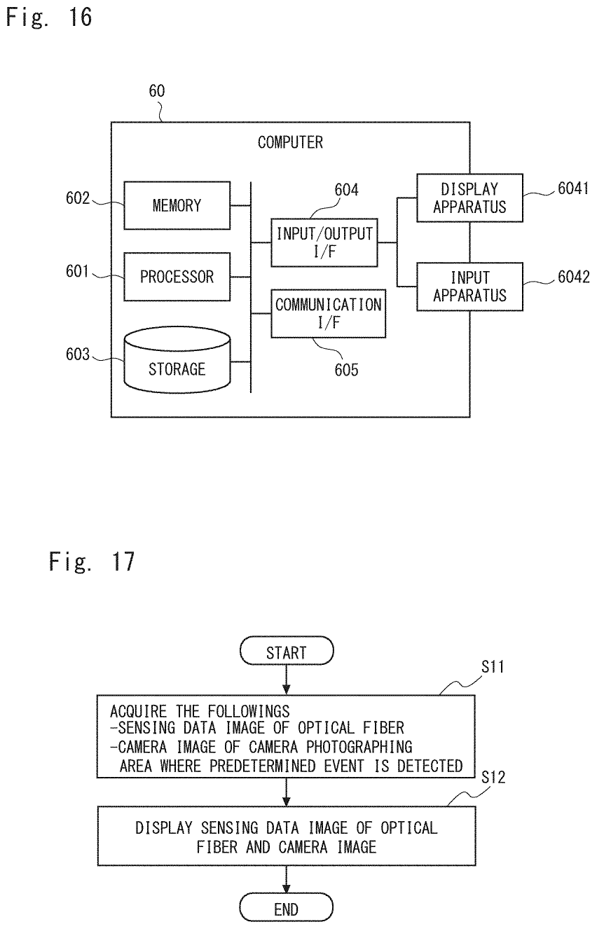

Next, a hardware configuration of a computer 60 that implements the image processing apparatus 40 will be described with reference to FIG. 16.

As shown in FIG. 16, the computer 60 includes a processor 601, a memory 602, a storage 603, an input/output interface (input/output I/F) 604, a communication interface (communication I/F) 605, and so on. The processor 601, the memory 602, the storage 603, the input/output interface 604, and the communication interface 605 are connected by a data transmission path for transmitting data to and receiving data from each other.

The processor 601 is an arithmetic processing apparatus such as a CPU (Central Processing Unit) or a GPU (Graphics Processing Unit). The memory 602 is a memory such as a RAM (Random Access Memory) or a ROM (Read Only Memory). The storage 603 is a storage apparatus such as an HDD (Hard Disk Drive), an SSD (Solid State Drive), or a memory card. The storage 603 may be a memory such as a RAM or a ROM.

The storage 603 stores a program that implements the function of the control unit 41 included in the image processing apparatus 40. The processor 601 implements the function of the control unit 41 by executing the program. Here, the processor 601 may execute the program after reading it into the memory 602 or without reading it into the memory 602. The memory 602 and the storage 603 also play a role to store information and data held by the control unit 41.

The above program can be stored and provided to a computer (including the computer 60) using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Compact Disc-Read Only Memory), CD-R (CD-Recordable), CD-R/W (CD-ReWritable), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 604 is connected to a display apparatus 6041, an input apparatus 6042, and so on. The display apparatus 6041 implements the display unit 42 and displays a screen corresponding to drawing data processed by the processor 601, such as an LCD (Liquid Crystal Display) or a CRT (Cathode Ray Tube) display. The input apparatus 6042 receives an operator's operation input and is, for example, a keyboard, a mouse, and a touch sensor. The display apparatus 6041 and the input apparatus 6042 may be combined and implemented as a touch panel.

The communication interface 605 transmits data to and receives data from an external apparatus. For example, the communication interface 605 communicates with an external apparatus via a wired communication path or a wireless communication path.

### Operation of Embodiment

Hereinafter, an operation of the image processing apparatus 40 according to the first embodiment will be described. Here, an operation flow of the image processing apparatus 40 according to the first embodiment will be described with reference to FIG. 17. Note that FIG. 17 shows an operation after the control unit 41 detects a predetermined event occurring in the fence 10 based on the sensing data generated by the optical fiber detection unit 30.

As shown in FIG. 17, when the control unit 41 detects a predetermined event occurring in the fence 10, the control unit 41 controls the camera 50 which photographs an area including the fence 10 and acquires a camera image of the camera 50 together with sensing data generated by the optical fiber detection unit 30 (Step S11). Note that since the control unit 41 has already acquired the sensing data for detecting the predetermined event, if the sensing data is held, it is not necessary to acquire the sensing data again in Step S11.

After that, the control unit 41 controls the display unit 42 to display a sensing data image indicating the sensing data and a camera image of the camera 50 which photographs the area including the fence 10 where the predetermined event is detected (Step S12). Specifically, the control unit 41 controls the display unit 42 to display the images as in the Display Example 1. Alternatively, the control unit 41 may control the display unit 42 to display the images as in the Display Example 2 or Display Example 3.

### Effect of Embodiment

As described above, according to this embodiment, the sensing data image indicating the sensing data of the optical fiber and the camera image of the camera 50 which photographs the area including the fence 10 where the predetermined event is detected by the sensing data are displayed on the display unit 42. In this way, since not only the camera image of the camera 50 which photographs the area including the fence 10 where the predetermined event is detected, but also the sensing data image that is to be based on for the detection are displayed, it becomes easy for a monitoring person to visually recognize that the predetermined event (abnormality) has occurred.

Moreover, according to the first embodiment, the optical fiber sensing technique which uses an optical fiber as a sensor is used. Thus, this embodiment has advantages such that an optical fiber is not affected by electromagnetic noises, it is not necessary to supply power to a sensor, and it is possible to achieve excellent environmental resistance and easy maintenance.

### Second Embodiment

In the above-described first embodiment, an example in which the fences 10 are installed outdoors is described.

In contrast, the second embodiment is an example in which the fences 10 are experimentally installed indoors (in a room, to be more specific).

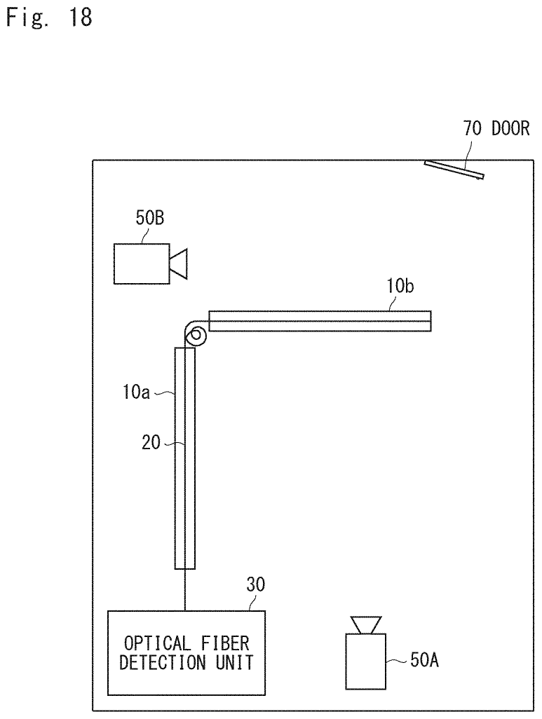

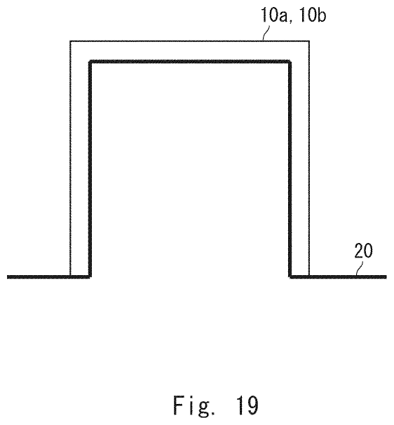

FIG. 18 is an overhead view of an entire room in which the fences 10 according to the second embodiment are installed as seen from above.

As shown in FIG. 18, two fences 10a and 10b are arranged in an L shape in the room. As shown in FIG. 19, an optical fiber cable 20 is laid on the two fences 10a and 10b. However, the method of laying the optical fiber cable 20 shown in FIG. 19 is an example and is not limited to this.

In the second embodiment, one of predetermined events that occur in the fences 10a and 10b is an event that a person touches the fences 10a and 10b. Therefore, cameras 50A and 50B are installed in the room so that the fences 10a and 10b can be photographed when a person touches the fences 10a and 10b. Further, a door 70 is installed in the room, and a person enters and exits the room through the door 70.

Note that in FIG. 18, the components constituting an image processing apparatus 40 are not shown, since they are assumed to be arranged outside the room. However, the present disclosure is not limited to this, and the optical fiber detection unit 30 may also be disposed outside the room.

Further, the only difference between the monitoring system according to the second embodiment and that according to the above-described first embodiment is that, in the first embodiment, the fences 10 are installed indoors. The basic configuration and operation of the first embodiment are the same as those of the second embodiment. Therefore, hereinafter, only specific Display Examples displayed by the display unit 42 according to the second embodiment will be described.

### (1) Display Example 1

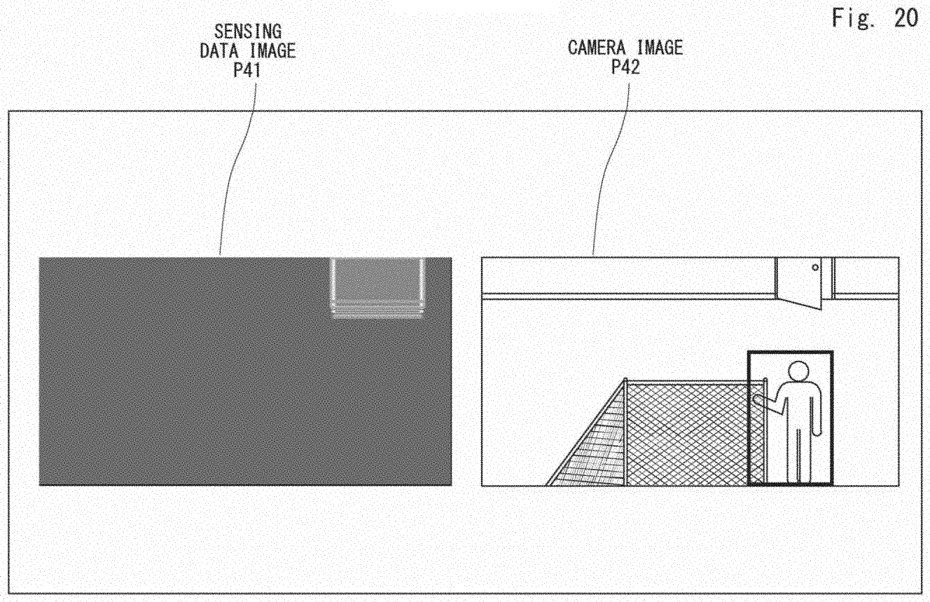

First, a Display Example 1 will be described with reference to FIG. 20.

As shown in FIG. 20, in the Display Example 1, a sensing data image P41 and a camera image P42 are displayed. Note that an arrangement relationship between the sensing data image P41 and the camera image P42 is not limited to this example.

The sensing data image P41 indicates sensing data generated by the optical fiber detection unit 30. Here, the sensing data indicates that a person has touched the fence 10b. Thus, the control unit 41 detects an event that a person is touching the fence 10b and controls the camera 50A which photographs an area including the fence 10b.

The camera image P42 is a camera image of the camera 50A which photographs the area including the fence 10b and is controlled by the control unit 41. In the camera image of the camera 50A, a person is surrounded by a square frame (the same applies to the following Display Examples).

### (2) Display Example 2

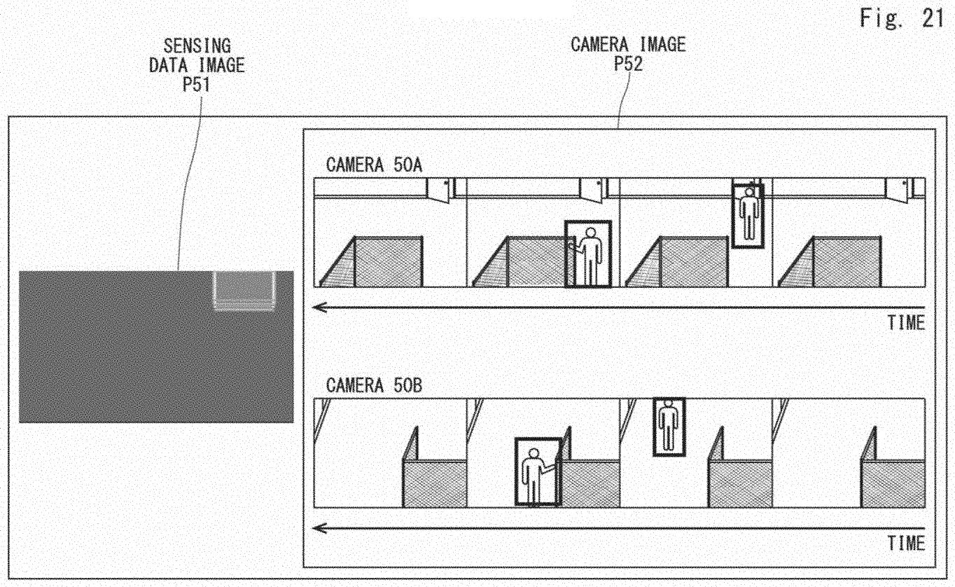

Next, a Display Example 2 will be described with reference to FIG. 21.

As shown in FIG. 21, in the Display Example 2, a sensing data image P51 and a camera image P52 are displayed. Note that an arrangement relationship between the sensing data image P51 and the camera image P52 is not limited to this example.

Like in the Display Example 1, in this Display Example 2, the control unit 41 detects an event that a person is touching the fence 10b. However, in this Display Example 2, unlike the Display Example 1, the control unit 41 controls the two cameras 50A and 50B which photograph an area including the fence 10b.

Thus, the camera image P52 includes the camera images of the two cameras 50A and 50B controlled by the control unit 41. Furthermore, each of the camera images of the cameras 50A and 50B includes not only an image at the time when the above-described event is detected (second image from the left) but also an image after this time (leftmost image) and images before the time (third and fourth images from the left). At this time, in order to easily distinguish the image at the time when the above-described event is detected (second image from the left) from the other images, the image may be displayed in an emphasized manner, for example, by placing a symbol or a thick frame line on the image at the time when the above-described event is detected.

Note that the camera images of the cameras 50A and 50B may be switched upside down. The order in which the camera images of the cameras 50A and 50B are arranged one above the other may be selected by the user.

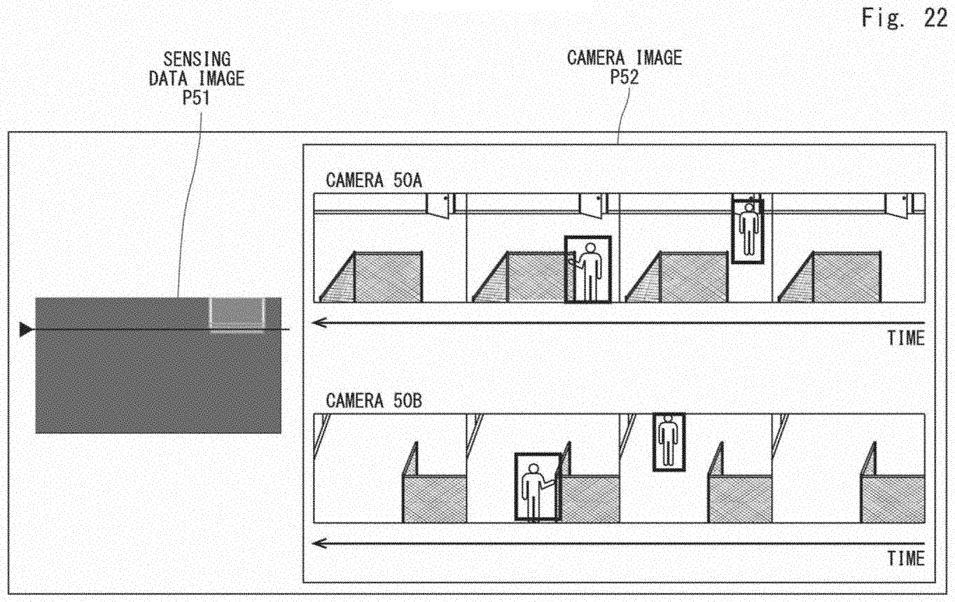

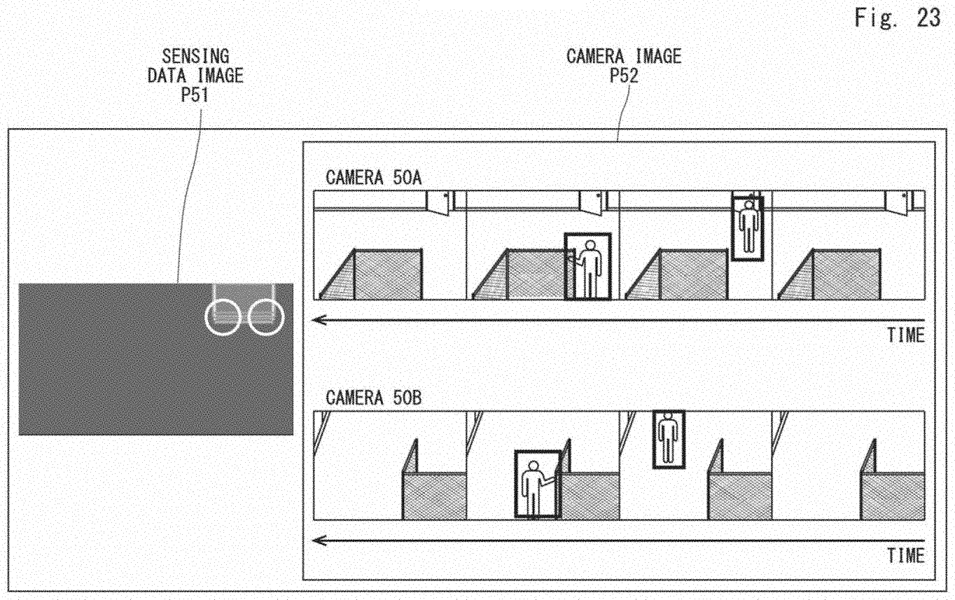

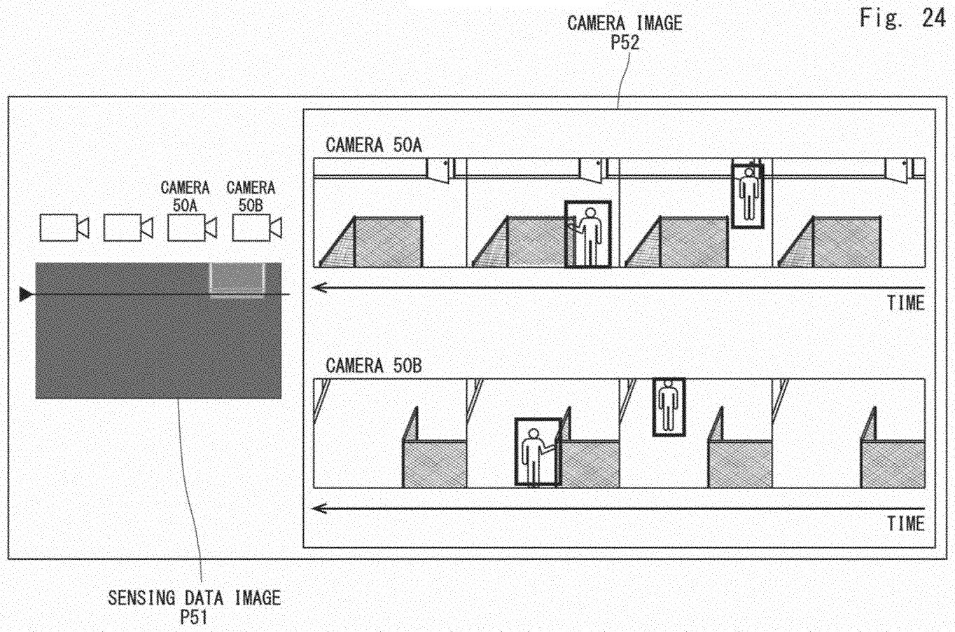

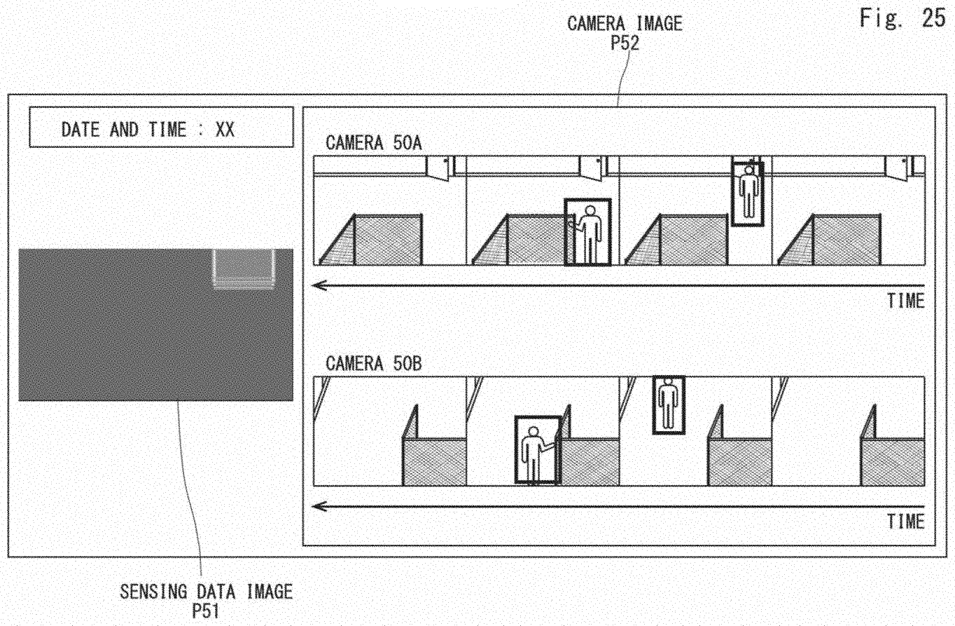

In addition, as for the sensing data image P51 and the camera image P52, by the user designating a specific period of time or time and the camera 50, the sensing data P11 at the specified time and the camera image P52 of the camera 50 corresponding to the location of the detected vibration data may be displayed. Specifically, as shown in FIG. 22, the user designates a predetermined period of time on the vertical axis of the sensing data image P51. The control unit 41 identifies the vibration data detected at this predetermined period of time and displays the camera image P52 of the camera 50 corresponding to the location of the vibration data. Further, as shown in FIG. 23, the user may designate not only the predetermined period of time on the vertical axis of the sensing data image P51 but also the place on the horizontal axis. The control unit 41 displays the camera image P52 of the camera 50 corresponding to the predetermined period of time and place designated by the user. Furthermore, as shown in FIG. 24, the user may designate the predetermined period of time on the vertical axis of the sensing data image P51 and the camera 50 displayed along the horizontal axis (place) of the sensing data image P51. The control unit 41 displays the predetermined period of time and the camera image P52 of the camera 50A or 50B designated by the user. Further, as shown in FIG. 25, the user may designate a predetermined date and time. The control unit 41 identifies the sensing data image P51 at a predetermined interval before and after the designated date and time (e.g., one hour before and one hour after the designated date and time) and the vibration data detected at the designated date and time and displays the camera image P52 of the camera 50 corresponding to the location of the identified vibration data.

In the second embodiment, since only two cameras 50A and 50B are provided, the camera images of the cameras 50A and 50B can be included in the camera image P52. However, when the number of cameras 50 is large and the control unit 41 controls a larger number of cameras 50, camera images of all the cameras 50 controlled by the control unit 41 may not be included in the camera image P52. In such a case, the camera image included in the camera image P52 may be selected by the user.

The sensing data image P51 is similar to the sensing data image P41 in FIG. 20.

### (3) Display Example 3

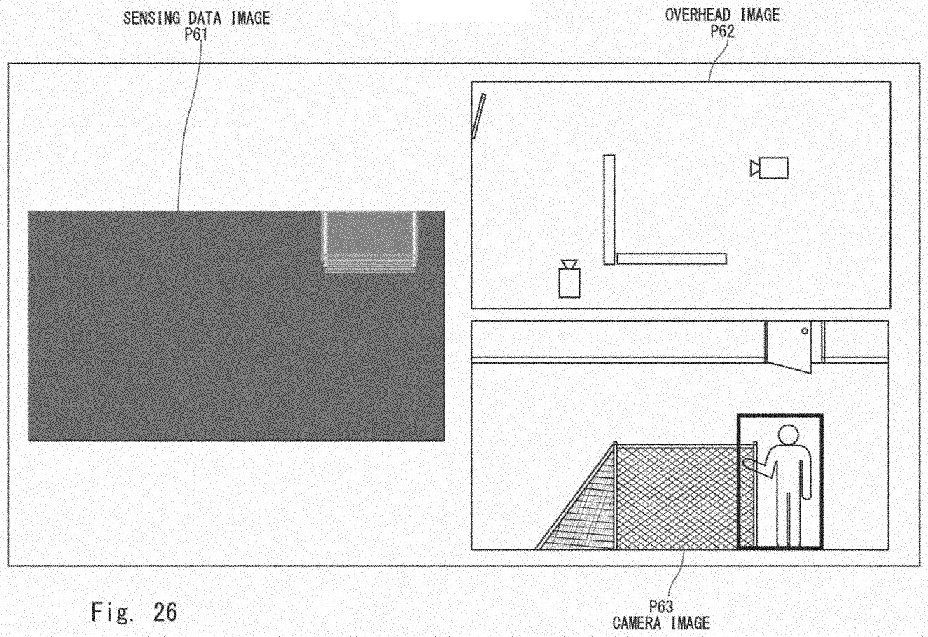

Next, a Display Example 3 will be described with reference to FIG. 26.

As shown in FIG. 26, in the Display Example 3, a sensing data image P61, an overhead image P62, and a camera image P63 are displayed. Note that an arrangement relationship of the sensing data image P61, the overhead image P62, and the camera image P63 is not limited to this example.

The overhead image P62 is an image of the entire room where the fences 10a and 10b are installed as seen from above.

The camera image P63 is similar to the camera image P42 of FIG. 20 and is a camera image of the camera 50 (camera 50A in this example) controlled by the control unit 41. However, the present disclosure is not limited to this, and instead, when the user selects the camera 50 in the overhead image P62, the camera image of the camera 50 selected by the user may be displayed as the camera image P63. The camera image P63 may be made similar to the camera image P52 of FIG. 21.

The sensing data image P61 is similar to the sensing data image P41 in FIG. 20.

### (4) Display Example 4

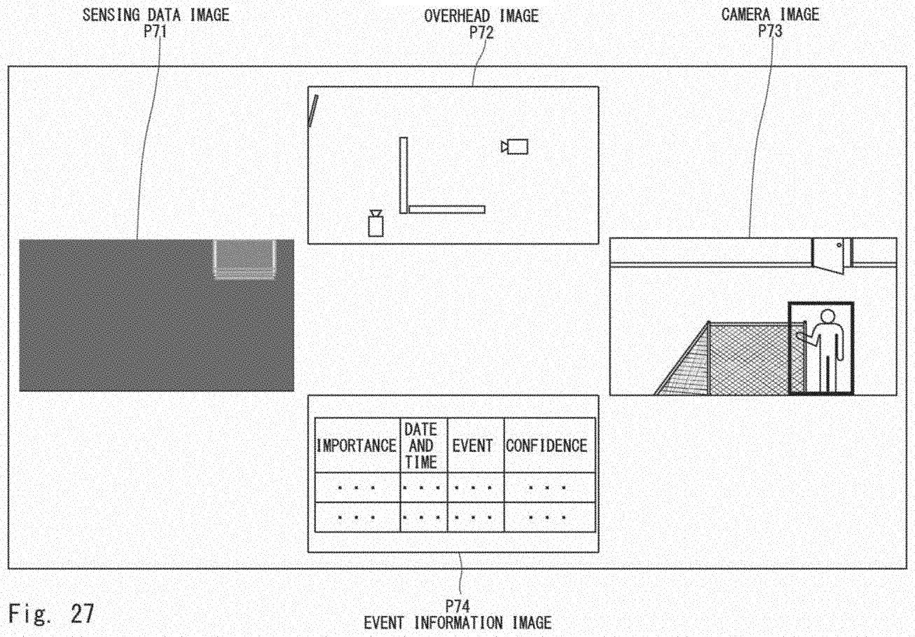

Next, a Display Example 4 will be described with reference to FIG. 27.

As shown in FIG. 27, in the Display Example 4, a sensing data image P71, an overhead image P72, a camera image P73, and an event information image P74 are displayed. Note that an arrangement relationship of the sensing data image P71, the overhead image P72, the camera image P73, and the event information image P74 is not limited to this example.

The event information image P74 indicates event information representing an occurrence status of an event. In the example of FIG. 27, the event information includes an importance of an event, date and time when the event has occurred, a type of the event, and confidence with which the event has occurred. The importance of an event is set based on the confidence and a priority of the event. For example, an importance of an event “person climbs fence 10” is set higher, and a priority of this event is set higher than that of an event “person or animal wanders around fence 10” to be output.

Further, the event information image P74 may be configured in such a way that the user can select an event. Specifically, when the user designates a specific event from a plurality of events displayed in the event information image P74, the control unit 41 displays the sensing data image P71, the overhead image P72, and the camera image P73 corresponding to the date and time of this event.

The overhead image P72 is similar to the overhead image P62 of FIG. 26.

The camera image P73 is similar to the camera image P42 of FIG. 20 and is a camera image of the camera 50 (camera 50A in this example) controlled by the control unit 41. However, the present disclosure is not limited to this, and when the user selects the camera 50 in the overhead image P72, the camera image of the camera 50 selected by the user may be displayed as the camera image P73. Further, when the user selects an event in the event information image P74, a camera image at the date and time when the event has occurred may be displayed as the camera image P73. The camera image P73 may be similar to the camera image P52 of FIG. 21.

The sensing data image P71 is similar to the sensing data image P41 in FIG. 20. However, the present disclosure is not limited to this, and when the user selects an event in the event information image P74, an image indicating sensing data of the date and time when the event has occurred may be displayed as the sensing data image P61.

### (5) Display Example 5

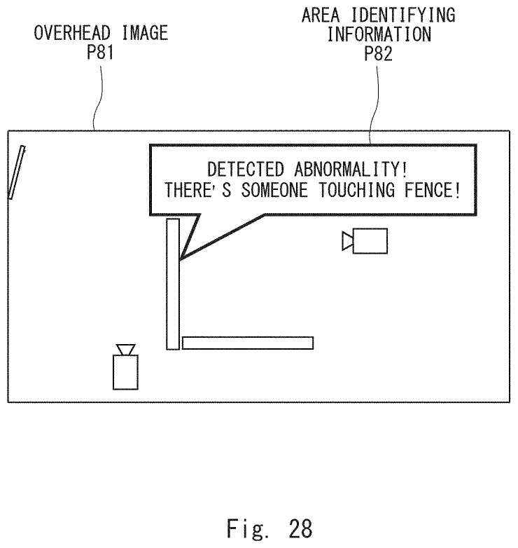

Next, a Display Example 5 will be described with reference to FIG. 28.

As shown in FIG. 28, in the Display Example 5, an image in which area identifying information P82 is superimposed on an overhead image P81 is displayed.

The overhead image P81 is similar to the overhead image P62 of FIG. 26. Like in this Display Example 1, in the Display Example 5, the control unit 41 detects an event that a person is touching the fence 10b.

The area identifying information P82 has a balloon shape. The area identifying information P82 indicates by an arrow an area including the location of the fence 10b in which the control unit 41 has detected an occurrence of the above-mentioned event with a warning message that a person is touching the fence 10b. The area identifying information P82 is superimposed on the overhead image P81 and displayed.

As described above, the basic configuration and operation of the second embodiment are the same as those of the first embodiment. Thus, the effect of the second embodiment is the same as that of the first embodiment.

### Other Embodiments

In the above-described embodiments, an example in which the monitoring target is the fences 10 has been described, but the monitoring target is not limited to the fences 10. First, the installation site of the monitoring target may be an airport, a port, a plant, a nursing facility, a company building, a border, a nursery, a home, or the like. The monitoring target may be, a wall, a pipeline, a utility pole, a civil engineering structure, a floor, etc. in addition to a fence. Further, a laying or burying site of the optical fiber cable 20 when the monitoring target is monitored may be a wall, a pipeline, a utility pole, a civil engineering structure, a floor, etc., in addition to a fence and underground. For example, when the fence 10 installed in a nursing facility is to be monitored, examples of a predetermined event that could occur in the fence 10 include a person hitting the fence 10, a person leaning against the fence 10 due to injury or the like, and a person climbing over the fence 10 to escape.

In the above-described embodiments, it has been described that the fence 10 vibrates when a predetermined event occurs. However, when such an event occurs, a sound, a temperature, a strain, a stress, and the like change in the fence 10, and these changes are transmitted to the optical fiber. The patterns of a sound, a temperature, a strain, a stress, and the like are also dynamically fluctuating patterns and differ according to the type of an event occurring in the fence 10. For this reason, the optical fiber detection unit 30 may use a Distributed Acoustic Sensor, a Distributed Temperature Sensor, etc. in addition to a distributed vibration sensor to detect a change in a vibration, a sound, a temperature, strain, and stress, etc. and generate sensing data. Then, the control unit 41 may detect an event occurring in the fence 10 based on the sensing data in which the change in the vibration, the sound, the temperature, the strain, and stress, etc. is reflected. This further improves a detection accuracy.

In the above-described embodiments, when a predetermined event is occurring in the fence 10, the control unit 41 controls the angle, zoom magnification, and so on of the camera 50 which photographs an area including this fence 10. However, the control unit 41 may continue to perform control even after a predetermined event has occurred. For example, the control unit 41 may control the camera 50 to track a person, an animal, a car, and the like present in the above-mentioned area. Moreover, when a person wandering around the fence 10 leaves an object such as a suspicious object, the control unit 41 may control one camera 50 to photograph the object and another camera 50 to track the person.

Moreover, the control unit 41 and the display unit 42 of the image processing apparatus 40 may be provided separately from each other. For example, the display unit 42 may be provided in a monitoring room, and the image processing apparatus 40 including the control unit 41 may be provided outside the monitoring room.

In the above-described embodiments, only one optical fiber detection unit 30 is provided and the optical fiber cable 20 is occupied. However, the present disclosure is not limited to this.

For example, the optical fiber detection unit 30 may be provided in a communication carrier station, and the optical fiber cable 20 may be shared between existing communication equipment provided inside the communication carrier station and the optical fiber detection unit 30.

Alternatively, one optical fiber detection unit 30 may be provided in each of the plurality of communication carrier stations, and the detection unit fiber cable 20 may be shared between the plurality of optical fiber detection units 30 provided in the plurality of respective communication carrier stations.

Further alternatively, a plurality of optical fiber detection units 30 may be provided in one communication carrier station, and the optical fiber cable 20 may be shared between the plurality of optical fiber detection units 30.

Although the present disclosure has been described with reference to the embodiments, the present disclosure is not limited to the above-described embodiments. Various changes that can be understood by those skilled in the art can be made to the configurations and details of the present disclosure within the scope of the present disclosure.

### REFERENCE SIGNS LIST

10, 10a, 10b FENCE
20 OPTICAL FIBER CABLE
30 OPTICAL FIBER DETECTION UNIT
40 IMAGE PROCESSING APPARATUS
41 CONTROL UNIT
42 DISPLAY UNIT
50, 50A to 50C CAMERA
60 COMPUTER
601 PROCESSOR
602 MEMORY
603 STORAGE
604 INPUT/OUTPUT INTERFACE
6041 DISPLAY APPARATUS
6042 INPUT APPARATUS
605 COMMUNICATION INTERFACE
70 DOOR
P11, P31, P41, P51, P61, P71 SENSING DATA IMAGE
P12, P34, P42, P52, P63, P73 CAMERA IMAGE
P21, P32, P62, P72, P81 OVERHEAD IMAGE
P22, P33, P82 AREA IDENTIFYING INFORMATION
P35, P74 EVENT INFORMATION IMAGE

What is claimed is:

1. An image processing apparatus comprising:
a display unit; and
a control unit configured to control the display unit to display a sensing data image indicating sensing data of an optical fiber and a camera image of a camera which photographs an area in which a predetermined event is detected by the sensing data.

2. The image processing apparatus according to claim 1, wherein
the control unit is configured to control the display unit to display information for identifying the area in which the predetermined event is detected by superimposing the information on an overhead image indicating an entire area in which the optical fiber is laid or buried.

3. The image processing apparatus according to claim 1, wherein
the control unit is configured to control the display unit to display each of camera images of two or more cameras which photograph the area in which the predetermined event is detected as the camera image displayed together with the sensing data image.

4. The image processing apparatus according to claim 1, wherein
the control unit is configured to control the display unit to display the camera images of the camera which photographs the area in which the predetermined event is detected at a time when the predetermined event is detected and before and after the time when the predetermined event is detected as the camera images to be displayed together with the sensing data image.

5. The image processing apparatus according to claim 1, wherein
the control unit is configured to control the display unit to display the overhead image indicating the entire area in which the optical fiber is laid or buried together with the sensing data image and the camera image.

6. The image processing apparatus according to claim 5, wherein
the control unit is configured to control the display unit to display an image indicating a status in which the predetermined event has occurred together with the sensing data image, the camera image, and the overhead image.

7. An image processing method performed by an image processing apparatus comprising:
acquiring a sensing data image indicating sensing data of an optical fiber and a camera image of a camera which photographs an area in which a predetermined event is detected by the sensing data; and
displaying the sensing data image and the camera image.

8. A non-transitory computer readable medium storing a program causing a computer to execute:
a procedure for acquiring a sensing data image indicating sensing data of an optical fiber and a camera image of a camera which photographs an area in which a predetermined event is detected by the sensing data; and
a procedure for displaying the sensing data image and the camera image.
